(19) United States
(12) Patent Application Publication
(10) Pub. No.: US 2026/0310883 A1
(43) Pub. Date: Oct. 8, 2026

(54) SYSTEM AND METHOD FOR AUTOMATED END-TO-END COMPUTATIONAL REPRODUCIBILITY AUDITING OF SCIENTIFIC RESEARCH

(71) Applicant: The Trustees of the Stevens Institute of Technology, Hoboken, NJ (US)

(72) Inventor: Jordan William Suchow, New York, NY (US)

(21) Appl. No.: 19/639,507

(22) Filed: Apr. 6, 2026

Related U.S. Application Data
(60) Provisional application No. 63/784,538, filed on Apr. 7, 2025.
(60) Provisional application No. 63/899,488, filed on Oct. 15, 2025.

(51) Int. Cl. G06F 40/166; G06F 9/445; G06F 9/455; G06F 11/3668; G06F 21/62; G06Q 10/0875; G06V 30/413

(52) U.S. Cl. CPC G06F 40/166; G06F 9/44505; G06F 9/45558; G06F 11/3688; G06F 21/6209; G06Q 10/0875; G06V 30/413; G06F 2009/45562

(57) ABSTRACT

A system for automated computational reproducibility auditing of scientific research comprises an input processing pipeline comprising identity resolution, paper retrieval, and resource discovery modules, an analysis pipeline comprising text extraction, a result extraction, and bill of materials construction modules, a reconstruction and execution environment comprising workspace reconstruction, analysis execution module, and result comparison modules, and a computing system to perform a method comprising receiving as input a paper identifier or informal descriptor, acquiring a digital form of the identified paper, extracting structured information from the paper, identifying key results from the paper, constructing a bill of materials for paper, obtaining necessary data files and code, synthesizing a scientific workflow specification, synthesizing a computation environment specification, constructing a workspace, executing analysis of the scientific workflow, comparing results obtained through reproduction with the key results extracted from the original paper, and synthesizing a report documenting the entire reproduction attempt.

### CROSS-REFERENCE TO RELATED APPLICATIONS

This application claims priority to U.S. provisional patent application No. 63/899,488 filed Oct. 15, 2025, and to U.S. provisional patent application No. 63/784,538 filed Apr. 7, 2025, each of which are incorporated herein by reference in their entirety.

### BACKGROUND OF THE INVENTION

When every advance in science and engineering is accompanied by a guarantee of computational reproducibility, innovation flourishes. But today, it is not, with the results of many published research papers proving impossible to recreate from the original data and code (Baker, 2016). Indeed only a small fraction of published work meets basic standards of computational reproducibility (Stodden et al., 2018). This irreproducibility represents a systemic vulnerability to the nation—it undermines our ability to rely on research outputs, wastes valuable resources, and slows scientific progress in every field.

There are many ongoing efforts to incrementally improve the computational reproducibility of research. Traditional approaches to this challenge rely on manual audits that identify irreproducible work to diagnose the severity of the problem (e.g., the DARPA SCORE program or the Management Science Reproducibility Collaboration), sharing of tools that scientists can choose to adopt (e.g., ReproZip, Docker, Code Ocean capsules, mybinder.org, and the Open Science Framework), changes to journal policies to mandate steps towards reproducibility (e.g., Management Science's data-sharing policy), and educational initiatives that teach individual scientists about best practices (e.g., Reproducibility for Everyone and the Berkeley Initiative for Transparency in the Social Sciences). These approaches have made valuable progress, but are inherently small-scale, expensive, and slow, operating over decadal timescales for catalyzing change.

At the same time, there are also many ongoing efforts to automate verification of computational reproducibility in the context of software. Efforts include reproducible builds which provide security by independently verifying that source code produces an artifact that is bitwise identical to a released binary (e.g., reproducible-builds.org/tools/), code-quality assessment through automated linting which is routinely integrated into software testing and continuous integration servers (e.g. pylint, Dependabot, DeepSource, DataDog, CodeSonar), and a variety of formal methods such as formal proof assistants (e.g., Coq, Isabelle/HOL, Lean), deterministic execution environments (e.g., Nix, Guix, DetTrace) and floating-point verification (e.g., Gappa, Flocq). However, these efforts are limited to reproducible software builds and auditing the correctness of software products, which are different in kind from research results reported in the scientific literature, and there has been no comparable automation for the computational reproducibility of scientific research results.

Further, existing studies of computational reproducibility have found alarming rates of failure and demonstrate the critical need for a systematic, automated approach to computational reproducibility that can scale across the scientific enterprise. Thus there is a need in the art for improved systems and methods for automated end-to-end computational reproducibility auditing of scientific research.

### SUMMARY OF THE INVENTION

Some embodiments of the invention disclosed herein are set forth below, and any combination of these embodiments (or portions thereof) may be made to define another embodiment.

In one aspect, a system for automated computational reproducibility auditing of scientific research comprises: an input processing pipeline comprising an identity resolution module, a paper retrieval module, and a resource discovery module; an analysis pipeline comprising a text extraction module, a result extraction module, and a bill of materials construction module; a reconstruction and execution environment comprising a workspace reconstruction module, an analysis execution module, and a result comparison module; and a computing system communicatively connected to the input processing pipeline, analysis pipeline, and reconstruction and execution environment, comprising a processor and a non-transitory computer-readable medium with instructions stored thereon, which when executed by the processor, perform steps comprising: receiving as input a paper identifier or informal descriptor; acquiring a digital form of the identified paper; extracting structured information from the paper; identifying key results from the paper which will be targeted for reproduction; constructing a bill of materials for the scientific work described in the paper; obtaining necessary data files and code; synthesizing a scientific workflow specification; synthesizing a computation environment specification; constructing a workspace; executing analysis of the scientific workflow; comparing results obtained through reproduction with the key results extracted from the original paper; and synthesizing a report documenting the entire reproduction attempt.

In some embodiments, the system further comprises a reproducibility pipeline comprising a reproducibility package generation module, and a distributed processing infrastructure.

In some embodiments, the system further comprises machine learning subsystems comprising a large language model (LLM) integration for methods interpretation, and feedback loops for adaptive learning from past audits.

In another aspect, a method for automated computational reproducibility auditing of scientific research, comprises: receiving as input a paper identifier or informal descriptor; acquiring a digital form of the identified paper; extracting structured information from the paper; identifying key results from the paper which will be targeted for reproduction; constructing a bill of materials for the scientific work described in the paper; obtaining necessary data files and code; synthesizing a scientific workflow specification; synthesizing a computation environment specification; constructing a workspace; executing analysis of the scientific workflow to produce a reproduced set of results corresponding to the key results; comparing the reproduced set of results with the key results extracted from the original paper; and synthesizing a report documenting the entire reproduction attempt.

In some embodiments, the received a formal identifier comprising a Digital Object Identifiers (DOIs), a URL pointing to a preprint or a journal article, a PubMed ID, or an OpenAlex ID, or wherein the received informal descriptor comprises a citation, a quote from the paper, or an author name and publication year.

In some embodiments, the method further comprises resolving the provided identifier to include up-to-date information about the paper it identifies, wherein the resolving is performed via a DOI resolution service, a related system, a general-purpose search engine, or domain-specific search engine.

In some embodiments, the method further comprises retrieving metadata for the paper via a query service or metadata provider, wherein the metadata includes information about the paper comprising at least one of a title, an author, an abstract, a keyword, a journal and associated information, a publication date, a citation data, and a disciplinary classification.

In some embodiments, the step of acquiring the digital form of the identified paper comprises an adaptive approach comprising at least one of making direct HTTP requests to known URLs, utilizing a query service to locate freely available versions, accessing via a subscription services, using alternative sources, contacting authors directly via email, deploying web crawlers to extract papers from websites lacking formal APIs, retrieving papers from preprint servers, and accessing bulk data downloads from publishers or aggregators.

In some embodiments, the structured information comprises at least one of a text, a table, and a figure.

In some embodiments, identifying key results from the paper which will be targeted for reproduction comprises at least one of using tools from natural language processing (NLP) that perform extractive summarization or abstractive summarization, and using a large language model (LLM) that leverages broad domain knowledge across scientific fields to accurately interpret results across different disciplines and presentation formats.

In some embodiments, the step of constructing a bill of materials for the scientific work described in the paper comprises using a dependency crawler to examine contents of the paper and metadata to extract dependencies and new location pointers, process dependencies that are at least one of explicitly defined and well-specified, explicitly defined but poorly specified, and implicitly defined.

In some embodiments, the step of obtaining necessary data files and code comprises obtaining the data files and code via at least one of a direct HTTP request to relevant servers, a specialized archival lookup tool or an application programming interface (API), a web crawler for sites without formal APIs, a paid service when necessary, and domain-specific search engine.

In some embodiments, the step of synthesizing a scientific workflow specification comprises generating a formal specification of the scientific workflow described in the paper, wherein the specification takes the form of a domain-specific language script or a domain-general language implementation, wherein the specification captures the sequence of at least one of analytical steps, data transformations, and computational procedures necessary to reproduce the paper's results.

In some embodiments, the step of synthesizing a computation environment specification comprises generating a specification of the computational environment required to execute the workflow, wherein the computation environment specification includes at least one of container definitions, Linux container configurations, declarative environment definitions, virtual machine specifications, infrastructure as code templates, and Kubernetes manifests.

In some embodiments, the step of constructing a workspace comprises a workspace manager creating and populating a structured environment for the reproduction attempt by performing at least one of establishing an appropriate directory structure, populating the workspace with the obtained data files and code, implementing appropriate access controls and resource allocations, creating virtual environments or containers based on the environment specification, and setting up appropriate configuration files.

In some embodiments, the step of executing analysis of the scientific workflow comprises using appropriate workflow management tools such that execution follows the formal workflow specification, operates within the computational environment, uses the constructed workspace, records detailed logs of all operations and intermediate outputs, and tracks resource utilization and execution time, wherein the execution performs the actual computational reproduction of the paper's analysis.

In some embodiments, the method further comprises, when execution errors occur, debugging and refining the analysis via an AI debugging module with tool use capabilities to at least one of identify and diagnose execution errors, examine output logs and error messages, suggest and implement fixes for identified issues, resolve dependency conflicts by testing various configurations, modify code or workflow specifications as needed, and retry execution with corrected parameters.

In some embodiments, the step of comparing results obtained through reproduction with the key results extracted from the original paper comprises using comparison tools employing statistical methods to at least one of performing statistical tests across multiple runs to account for stochasticity, assessing whether observed differences fall within acceptable ranges for the discipline, and producing a graded assessment of reproduction success.

In some embodiments, the step of synthesizing a report documenting the entire reproduction attempt comprises integrating logs and digital traces from all previous steps, wherein the synthesizing is implemented directly via logging statements of all previous steps, via a templating engine, or via an LLM that takes as input the logs, digital traces of the previous steps, and a formal specification of reproducibility report, and outputs a report that reflects the input information and conforms to the specification.

In another aspect, a non-transitory computer-readable medium storing instructions that, when executed by a processor, cause the processor to perform method steps comprising: receiving as input a paper identifier or informal descriptor; acquiring a digital form of the identified paper; extracting structured information from the paper; identifying key results from the paper which will be targeted for reproduction; constructing a bill of materials for the scientific work described in the paper; obtaining necessary data files and code; synthesizing a scientific workflow specification; synthesizing a computation environment specification; constructing a workspace; executing analysis of the scientific workflow; comparing results obtained through reproduction with the key results extracted from the original paper; and synthesizing a report documenting the entire reproduction attempt.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1 shows a system for automated computational reproducibility auditing of scientific research.

FIGS. 2A-2B show a flowchart depicting a method for automated computational reproducibility auditing of scientific research.

FIG. 3 shows a plot of scientific and engineering publications over time.

FIG. 4 shows a plot of a simulation of scientific and engineering publications reproduced using the systems and methods herein over time.

FIG. 5 shows an exemplary computing environment in which aspects of the invention may be practiced.

### DETAILED DESCRIPTION OF THE INVENTION

It is to be understood that the figures and descriptions of the present invention have been simplified to illustrate elements that are relevant for a clearer comprehension of the present invention, while eliminating, for the purpose of clarity, many other elements found in systems and methods for automated end-to-end computational reproducibility auditing of scientific research. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, exemplary methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Ranges: throughout this disclosure, various aspects of the invention can be presented in a range format. It should be understood that the description in range format is merely for convenience and brevity and should not be construed as an inflexible limitation on the scope of the invention. Where appropriate, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Referring now in detail to the drawings, in which like reference numerals indicate like parts or elements throughout the several views, in various embodiments, presented herein are systems and methods for automated end-to-end computational reproducibility auditing of scientific research.

In some embodiments, the present invention relates generally to systems and methods for verifying scientific research, and more particularly to an automated system for auditing the computational reproducibility of published scientific papers at scale.

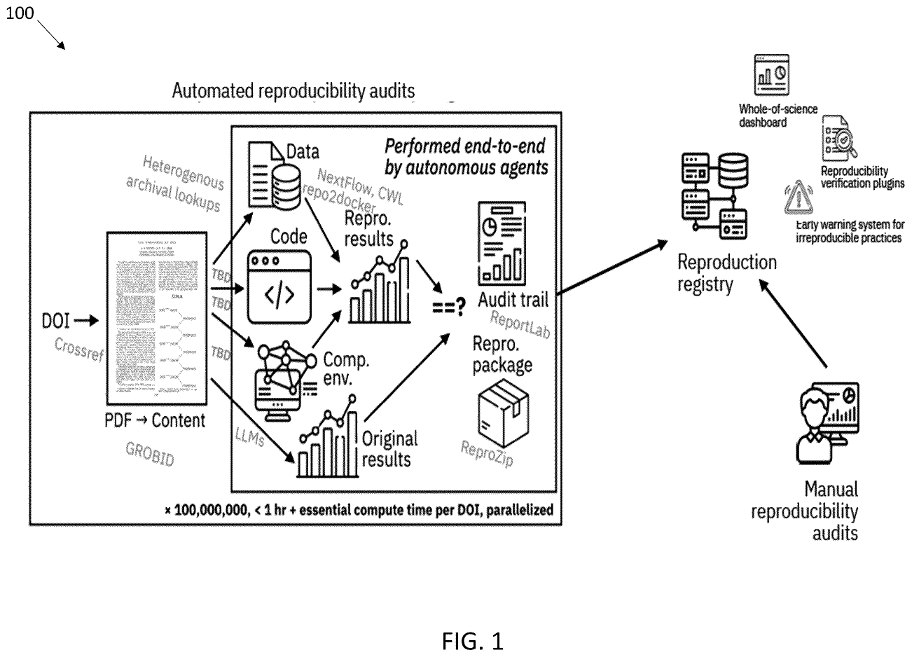

In some embodiments, the system 100 (FIG. 1) resolves a digital object identifier (DOI) or other identifiers for a scientific paper, automatically discovers associated data and code resources, reconstructs the computational environment using containerization, executes the computational workflow, validates the results against those reported in the publication, and/or generates a comprehensive reproducibility profile. In some embodiments, the system 100 follows a structured pipeline comprising identity resolution, paper retrieval, text extraction, result extraction, bill of materials construction, workspace reconstruction, analysis execution, and/or result comparison. In some embodiments, the system 100 employs machine learning techniques, distributed cloud infrastructure, and/or standardized reproducibility packages to scale across the scientific literature, providing an evolving record of reproducibility status that becomes part of the scientific record itself.

In some embodiments, the disclosed systems and methods provide a technology that solves the irreproducibility problem through an automated system that tracks and audits the computational reproducibility of published research. In some embodiments, the system 100 given the Digital Object Identifier (DOI) or other identifier of any paper from the scientific literature or prepublication manuscript provides immediate access to a reproducibility profile for that paper detailing how the paper fared in an automated audit of its computational reproducibility, where to find its associated data and code, and a complete audit trail of past verification attempts.

In some embodiments, the system 100 not only reports on but fully conducts reproducibility audits automatically, end-to-end, for a majority or every paper that has ever been published in a journal, conference, workshop, or preprint server. For each paper the system 100 performs one or more of: resolving the DOI or other identifier; finding the original data and code through internet search, archive lookups, and/or communication with the authors; constructing a computational environment in which to execute that code; running the code against the associated data; assessing whether the resultant analyses computationally reproduce what is reported in the paper; and/or generating an audit trail and reproducibility package associated with the reproduction attempt.

In some embodiment, this technical advancement is achieved through an integrated pipeline that follows a sequence of steps:
Identity Resolution: Converting a paper's identifiers (such as DOI) into its corresponding webpage or repository location.
Paper Retrieval: Obtaining the paper file (PDF, etc.) from the identified webpage.
Text Extraction: Converting the file into processable text.
Result Extraction: Identifying one or more computational results from the text.
Bill of Materials Construction: Generating a comprehensive list of all required resources.
Workspace Reconstruction: Creating a computational environment with necessary data, code, and dependencies.
Analysis Execution: Running the code within the reconstructed environment.
Result Comparison: Evaluating consistency between generated results and those reported in the paper.

In some embodiment, when authors haven't provided reproducibility materials, the system 100 proactively constructs a standardized reproducibility package that bridges the gap between current practices and reproducibility standards. The outcome is not just verification, but a permanent, evolving record of a paper's reproducibility status that becomes part of the scientific record itself. This aligns with recommendations from the National Academies of Sciences, Engineering, and Medicine (2019) for developing automated tools to support computational reproducibility.

### System Architecture

In some embodiments, the automated computational reproducibility audit system comprises several integrated components that work together to provide end-to-end verification of scientific research. FIG. 1 illustrates the overall architecture of the system 100.

In some embodiments, the system 100 comprises an input processing pipeline, an analysis pipeline, an execution environment, and/or a result validation framework. Each component can be modular, allowing for independent development and improvements while maintaining interoperability through standardized interfaces.

### Input Processing Pipeline

### Identity Resolution Module:

In some embodiments, the input processing pipeline includes an identity resolution module serving as the entry point for the reproducibility audit process. Given a digital object identifier (DOI) for a scientific paper or other identifying information, this module validates the identifier format and existence, interfaces with CrossRef or a similar API to retrieve paper metadata and URL, extracts basic paper metadata (authors, journal, publication date, etc.), and/or stores metadata in the system database.

In some embodiments, the module implements retry logic for handling temporary network failures or similar, and follows identity resolution standards for redirects. For identifiers that cannot be resolved through CrossRef, the system 100 attempts alternative resolution methods through repositories like DataCite or direct publisher APIs.

### Paper Retrieval Module:

In some embodiments, once the paper's URL has been identified, a paper retrieval module retrieves the paper file (typically PDF) from the publisher's website, handles authentication challenges using institutional access where available, implements fallback retrieval methods for papers behind paywall, attempts to locate open access versions through services like Unpaywall or Semantic Scholar, generates SHA-256 hashes of all retrieved artifacts for integrity verification, and/or creates a standardized directory structure for storing the retrieved files.

In some embodiments, fallback retrieval methods may include querying aggregators (e.g., CORE, PubMed Central), searching institutional repositories, contacting corresponding authors directly via automated email templates, employing subscription-based APIs (e.g., JSTOR, ScienceDirect), leveraging archival services (e.g., ResearchGate, Academia.edu), or, where permitted, using cached or mirrored copies (e.g., LOCKSS, arXiv mirror sites). The module may attempt these methods sequentially or in parallel, prioritizing sources according to availability and licensing constraints.

In some embodiments, the module supports multiple file formats beyond PDFs, including HTML, XML, and LaTeX source when available. In some embodiments, the module supports multiple file formats beyond PDFs, including HTML, XML, LaTeX source, Markdown, Jupyter notebooks, word processor documents (e.g., DOCX, ODT, RTF), spreadsheets (e.g., CSV, XLSX), and presentation files (e.g., PPTX), as well as preprint source bundles when available. For each retrieval attempt, detailed logs are maintained to document the success or failure of the retrieval process.

### Resource Discovery Module:

In some embodiments, a resource discovery module extends the paper retrieval process to locate additional and/or all artifacts associated with the paper and identifies, retrieves supplementary materials directly linked from the paper, searches for data repositories mentioned in the paper (e.g., Dryad, Figshare, GitHub), locates code repositories referenced in the publication, identifies dependencies mentioned in the paper's methods section, attempts to locate preprints or other versions of the paper that might contain additional resources, and/or records all discovered resources in a standardized manifest file.

In some embodiments, for papers where direct links to data and code are absent, the module employs more sophisticated strategies and searches academic repositories based on author names and paper titles, queries general-purpose search engines with targeted keywords, crawls institutional websites of the authors, and/or attempts to locate related papers that might reference the same datasets.

In some embodiments, all discovery attempts are logged with timestamps, success/failure status, and the retrieval method used.

### Analysis Pipeline

### Text Extraction Module:

In some embodiments, a text extraction module processes the retrieved paper files to extract their textual content, employs optical character recognition (OCR) and PDF parsing techniques for PDF files, extracts structured content while preserving formatting for HTML/XML files, processes supplementary materials based on their file formats, identifies and extracts tables, figures, and captions, preserves document structure (sections, subsections, references), and/or generates quality metrics for the extraction process.

In some embodiments, the module handles multilingual content and specialized scientific notation, including mathematical expressions and chemical formulas. For extraction failures, the system 100 records detailed error information and attempts alternative extraction strategies.

### Result Extraction Module:

In some embodiments, a result extraction module identifies computational results from the extracted text using a combination of rule-based approaches and machine learning techniques, employs large language models (LLMs) to identify claims and results in the paper, extracts numerical results, statistical tests, and p-values, identifies figures and tables containing computed results, links results to methods descriptions, extracts parameters and configurations used in the analysis, and/or creates a structured representation of each identified result.

In some embodiments, the LLM-based approach is guided by prompt engineering techniques that instruct the model to focus on computational results. In some embodiments, for each extracted result the module records the claim or finding associated with the result, the specific numerical values or visual representations, the statistical methods used to derive the result, the section and page where the result appears, and/or confidence scores for extraction accuracy.

In some embodiments, this structured information forms the basis for later comparison with reproduced results.

### Bill of Materials Construction Module:

In some embodiments, a bill of materials (BOM) construction module generates a comprehensive inventory of all computational resources required to reproduce the paper's results, identifies data files mentioned in the paper, extracts code references and snippets, determines software dependencies and versions, identifies hardware requirements (e.g., GPU, memory constraints), determines configuration parameters and settings, and/or identifies computational workflows described herein.

In some embodiments, the module leverages LLMs with tool use capabilities to parse methods sections and extract detailed information about the computational environment. In some embodiments, for each identified resource the BOM includes resource type (data, code, software, hardware), location or reference information, version information when available, role in the computational workflow, relationships to other resources, and/or alternative sources or equivalents.

In some embodiments, the resulting BOM serves as a blueprint for the workspace reconstruction process.

### Reconstruction and Execution Environment

### Workspace Reconstruction Module:

In some embodiments, a workspace reconstruction module creates a reproducible computational environment based on the bill of materials, acquires the necessary data files from identified sources, retrieves code from repositories or recreates it from description, resolves software dependencies using package managers, constructs containerized environments using Docker or Singularity, configures hardware resources according to requirements, sets up necessary file structures and permissions, and/or implements version control for tracking changes. In some embodiments, the workspace reconstruction module can organize files into the appropriate directory structure, or create symlinks as needed.

In some embodiments, for incomplete or unavailable resources, the module attempts to recreate missing data from descriptions or partial information, generates code from pseudocode or algorithm descriptions, identifies compatible alternatives for unavailable software, and/or reconstructs parameters from contextual information.

In some embodiments, the reconstructed workspace is encapsulated in a container to ensure isolation and reproducibility. In some embodiments, the container specification includes base operating system, installed software packages and versions, environment variables and configurations, mounted data volumes, initialization scripts, and/or resource limits and constraints.

In some embodiments, this containerized environment serves as a portable, self-contained unit for executing the computational analysis.

### Analysis Execution Module:

In some embodiments, an analysis execution module runs the computational workflow within the reconstructed environment, executes the code according to the described workflow, monitors resource usage and performance, captures standard output and error streams, logs intermediate results and state changes, handles errors and exceptions gracefully, Implements timeout and resource limit enforcement, and/or generates execution provenance information.

In some embodiments, the module supports sequential execution of steps in a defined order, parallel execution of independent tasks, interactive execution requiring user input (simulated), and/or randomized execution with controlled seed values.

In some embodiments, for workflows requiring specialized hardware (e.g., GPUs, HPC clusters), the module interfaces with appropriate resource providers through standardized APIs.

In some embodiments, all execution steps are logged in detail, creating a comprehensive audit trail that documents command invocations with timestamps, parameter values used, intermediate outputs, resource utilization metrics, error conditions and recovery attempts, and/or Environment variables and configurations.

In some embodiments, this audit trail ensures transparency and provides diagnostic information for reproduction failures.

### Result Comparison Module:

In some embodiments, a result comparison module evaluates the consistency between the results generated by the execution and those reported in the original paper, extracts results from the execution outputs, normalizes result formats for comparison, applies statistical tests for numerical results, performs visual comparison for figures and plots, accounts for acceptable numerical precision differences, and/or generates detailed comparison reports.

In some embodiments, the comparison process employs various strategies depending on the result type. For numerical results, statistical equivalence testing within defined tolerance levels is used. For tabular data, cell-by-cell comparison with allowance for formatting differences is used. For figures, image comparison algorithms that focus on data representation rather than stylistic elements is used. For text outputs, semantic comparison that accounts for wording variations is used.

In some embodiments, the module produces a structured report for each comparison including match status (exact match, approximate match, mismatch, or inconclusive), detailed differences when applicable, confidence score for the comparison, potential explanations for discrepancies, and/or recommendations for resolving differences.

In some embodiments, these comparison results form the core of the reproducibility assessment.

### Reproducibility Pipeline

### Reproducibility Package Generation Module:

In some embodiments, a reproducibility package generation module creates standardized, comprehensive packages documenting the entire reproduction process, assembles all artifacts used and generated during the audit, creates a manifest of all included files, generates provenance information linking results to sources, packages the containerized environment for future use, includes detailed logs and audit trails, adds reproducibility assessment reports, and/or digitally signs the package for integrity verification.

In some embodiments, the package follows a standardized structure to ensure consistency and interoperability including a metadata section with bibliographic information, original results extracted from the paper, reconstructed materials used for reproduction, execution logs and audit trails, reproduced results and comparison reports, and/or assessment conclusions and recommendations.

In some embodiments, this standardized structure enables automated processing and integration with other reproducibility tools and platforms.

### Distributed Processing Infrastructure:

In some embodiments, to scale the reproducibility audit process across tens of millions of papers, the system 100 employs a distributed processing infrastructure for cloud-based container orchestration for parallel processing, job scheduling optimized for resource utilization, intelligent prioritization of papers based on impact and feasibility, incremental processing that builds on previous audit attempts, fault tolerance mechanisms for handling failures, horizontal scaling capabilities for handling peak loads, and/or resource optimization to minimize processing costs.

In some embodiments, the infrastructure implements a worker pool model where papers are queued for processing based on priority algorithms, available workers claim papers from the queue, each worker independently processes its assigned paper, results are centrally aggregated and stored, workers report status and performance metrics, and/or the system 100 dynamically adjusts resource allocation.

In some embodiments, this distributed approach enables processing at a scale commensurate with the entire scientific literature, making comprehensive reproducibility auditing feasible for the first time.

### Machine Learning Subsystems

### LLM Integration for Methods Interpretation:

In some embodiments, the system 100 integrates large language models (LLMs) throughout the pipeline to interpret scientific methods and reconstruct computational workflows, employs sophisticated prompt engineering to extract structured information from text, uses few-shot learning with examples from similar papers, implements retrieval-augmented generation for domain-specific knowledge, combines multiple LLM queries with different prompts for robust extraction, leverages tool-using capabilities for direct interaction with external resources, and/or incorporates domain-specific knowledge through fine-tuning or retrieval enhancement.

In some embodiments, the LLM integration is designed to handle the diversity and complexity of scientific methods descriptions, enabling automated interpretation of papers across disciplines.

### Adaptive Learning From Past Audits:

In some embodiments, the system 100 incorporates feedback loops that improve performance based on past audit attempts, records successful and unsuccessful reproduction strategies, identifies patterns in reproduction failures, learns domain-specific heuristics for different scientific fields, adapts to emerging software environments and tools, refines extraction and comparison algorithms based on outcomes, and/or improves resource discovery strategies through reinforcement learning.

In some embodiments, this adaptive approach ensures that the system 100 continuously improves its performance, learning from both successes and failures to enhance future audit attempts.

### Reproducibility Method:

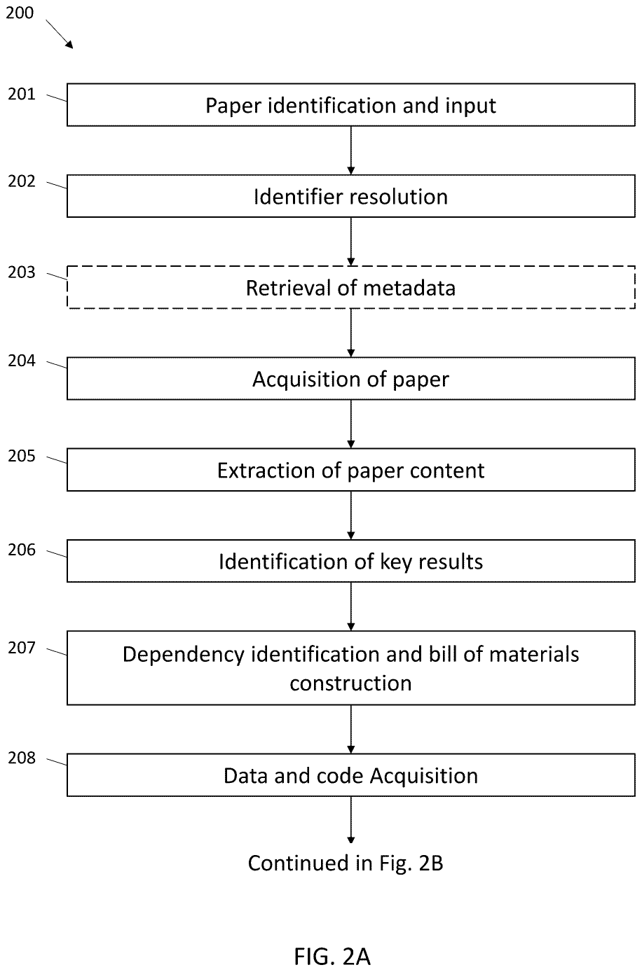

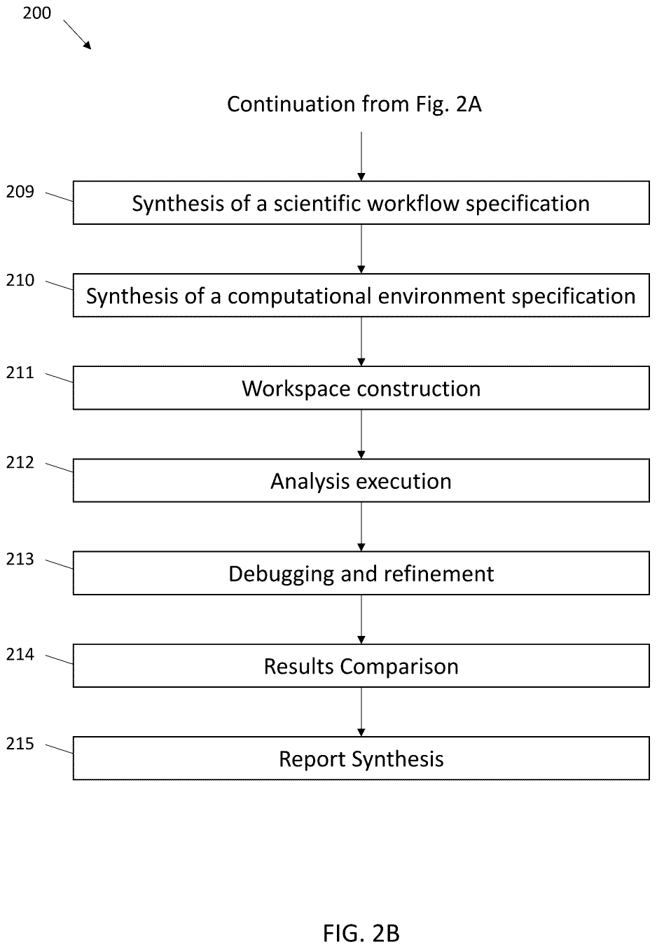

Described here is a method 200 (FIGS. 2A-2B) and system 100 (FIG. 1) for automating the end-to-end reproduction of research papers. This method and system addresses the critical issue of scientific reproducibility at scale, providing an automated framework that can extract results from published papers, construct detailed bills of materials, synthesize formal workflow specifications, execute analyses in controlled computational environments, and produce reports on reproduction attempts.

In some embodiments, the system 100 leverages an ecosystem of technologies spanning artificial intelligence (Large Language Models with tool use capabilities), scientific workflow management systems (Nextflow, Singularity CE), open science infrastructure (OpenAlex, doi.org, Crossref), and computing technologies (Docker, custom web crawlers) to create a pipeline that can systematically attempt to reproduce scientific papers across disciplines.

In some embodiments, the method utilizes the system's 100 fifteen interconnected modules, each of which are responsible for a specific aspect of the reproduction pipeline. The method may employ these modules detailed below in any order, and may employ only a subset of the modules as needed.

### Paper Identification and Input: (201)

In some embodiments, the system 100 accepts various forms of paper identifiers as input, including for example formal identifiers (Digital Object Identifiers (DOIs), URLs pointing to preprints or journal articles, PubMed IDs, OpenAlex IDs, etc.), and/or informal descriptors (Citations, quotes from the paper, author name and publication year, or any reasonably identifiable reference to the paper). This flexibility allows the system 100 to process reproduction attempts regardless of how the target paper is initially identified. In some embodiments, the system 100 may also accept identifiers such as arXiv IDs, PubMed Central IDs (PMCIDs), ISSNs/ISBNs, CrossRef or Scopus record IDs, ORCID-linked works, grant or clinical trial registry numbers, and/or internal catalog numbers from institutional repositories.

### Identifier Resolution: (202)

In some embodiments, the system 100 transforms the provided identifier into up-to-date information about the digital object it identifies. This resolution process may be performed through DOI resolution services (e.g., doi.org), other related systems (e.g., CrossRef, OpenAlex), general-purpose search engines (e.g., Google, Bing), or domain-specific search engines (e.g., Google Scholar). The resolution process ensures that the system 100 has accurate, current information about the paper regardless of the initial identifier format.

### Retrieval of Metadata (Optional): (203)

In some embodiments, to enhance contextual understanding, the system 100 can query services such as the OpenAlex API, CrossRef API, or other metadata providers to retrieve information about the paper, including its title and authors, abstract and keywords, journal and associated information, publication date, citation data, and disciplinary classification. This metadata provides context for subsequent processing steps and helps inform the dependency identification process.

### Acquisition of Paper: (204)

In some embodiments, the system 100 employs multiple strategies to obtain the full paper, using an adaptive approach that can make direct HTTP requests to known URLs, query services like Unpaywall to locate freely available versions, access papers through subscription services (JSTOR, publisher platforms), use alternative sources (Sci-Hub, ResearchGate), contact authors directly via email, deploy web crawlers to extract papers from websites lacking formal APIs, retrieve papers from preprint servers (arXiv, bioRxiv), and/or access bulk data downloads from publishers or aggregators (CORE). The system 100 can be configured with prioritization rules for these methods or can attempt multiple approaches in parallel, utilizing the first successful retrieval.

### Extraction of Paper Content: (205)

In some embodiments, once the paper is obtained, the system 100 extracts structured information using a combination of tools. Text extraction can be performed using GROBID, pdfminer, or pandoc for example, table extraction can be performed using Tabula, or Camelot for example, and/or figure extraction can be performed using PDF image processors, or Vision Language Models (VLMs) for example.

### Identification of Key Results: (206)

In some embodiments, the system 100 identifies and extracts the key results that will be targeted for reproduction, in either a structured or unstructured format. This process may involve tools from NLP that perform extractive summarization or abstractive summarization, or LLMs that leverage their broad domain knowledge across scientific fields to accurately interpret results across different disciplines and presentation formats.

### Dependency Identification and Bill of Materials Construction: (207)

In some embodiments, a custom dependency crawler is leveraged to construct a bill of materials for the scientific work. The crawler begins with the original paper and extracted metadata, examines each location's contents to extract dependencies and new location pointers, and then processes dependencies that are explicitly defined and well-specified (e.g., versioned software packages), explicitly defined but poorly specified (e.g., unversioned dependencies), and/or implicitly defined (inferred dependencies not mentioned but required). This extraction can be performed via combination of LLMs, regular expressions, and tools such as pipreqs, r_freeze, and comparable tools. In some embodiments, the system 100 maintains a queue of locations to process. In some embodiments, the system 100 optionally deduplicates the bill of materials during the bill of materials construction.

In some embodiments, when conflicts or ambiguities arise (e.g., unspecified versions, conflicting requirements), the system 100 preserves these in the bill of materials to be resolved during the debugging phase (213), where various combinations can be empirically tested.

### Data and Code Acquisition: (208)

In some embodiments, based on the bill of materials, the system 100 obtains all necessary data files and code through direct HTTP requests to relevant servers, specialized archival lookup tools and APIs (OSF API, Zenodo API, GitHub API), web crawlers for sites without formal APIs, paid services when necessary (Figshare), and/or domain-specific search engines (Google Dataset Search).

### Synthesis of a Scientific Workflow Specification: (209)

In some embodiments, the system 100 uses program synthesis, typically through Large Language Models such as Claude 3.7 Sonnet or comparable models, to generate formal specifications of the scientific workflow described in the paper. These specifications may take the form of a domain-specific language scripts (Nextflow, Snakemake) or a domain-general language implementations (shell scripts, Python files). The workflow specification captures the sequence of analytical steps, data transformations, and computational procedures necessary to reproduce the paper's results.

### Synthesis of a Computational Environment Specification: (210)

In some embodiments, the system 100 synthesizes formal specifications of the computational environment required to execute the workflow. This may include container definitions (Dockerfile, Containerfile, OCI Image Specifications, Singularity CE definition files (.def)), Linux container configurations (LXC config files), Declarative environment definitions (.nix files), Virtual machine specifications (Vagrantfile), Infrastructure as code templates (.tf files), and/or Kubernetes manifests (YAML). These specifications ensure that the workflow executes in a controlled, reproducible environment regardless of the underlying hardware.

### Workspace Construction: (211)

In some embodiments, a custom workspace manager creates and populates a structured environment for the reproduction attempt by establishing an appropriate directory structure, populating the workspace with downloaded data and code, implementing appropriate access controls and resource allocations, creating virtual environments or containers based on the environment specification, and/or setting up appropriate configuration files. This creates a self-contained workspace that encapsulates all necessary components for the reproduction attempt.

In some embodiments, the workspace manager may, for example, create conda or venv environments, initialize Git repositories for version tracking, configure shell profiles and environment variables, mount external data volumes, set up shared memory or scratch directories, and enforce user/group permissions. Where required, this step may also provision full virtual machines with a specified operating system image (e.g., Ubuntu, CentOS) using virtualization frameworks such as Vagrant or cloud providers, in addition to lightweight containers.

### Analysis Execution: (212)

In some embodiments, the system 100 executes the scientific workflow using appropriate workflow management tools such as Nextflow. The execution follows the formal workflow specification, operates within the computational environment, uses the workspace constructed above, records detailed logs of all operations and intermediate outputs, and/or tracks resource utilization and execution time. This step performs the actual computational reproduction of the paper's analysis.

### Debugging and Refinement: (213)

In some embodiments, when execution errors occur, an AI debugging module with tool use capabilities (such as Claude Code or GPT-4o with Unix command access, e.g. the Claude Code research preview) is used to identify and diagnose execution errors, examine output logs and error messages, suggest and implement fixes for identified issues, resolve dependency conflicts by testing various configurations, modify code or workflow specifications as needed, and/or retry execution with corrected parameters. The debugging module can, if necessary, trigger revisions to earlier steps in the pipeline (such as the bill of materials or workflow specification) to create a feedback loop that improves reproduction success rates.

### Results Comparison: (214)

In some embodiments, the system 100 compares the results obtained through reproduction with the key results extracted from the original paper. This comparison may use custom comparison tools employing statistical methods, may perform statistical tests across multiple runs to account for stochasticity, may assess whether observed differences fall within acceptable ranges for the discipline, and/or may produce a graded assessment of reproduction success (e.g., precisely reproduced, approximately reproduced, failed to reproduce).

### Report Synthesis: (215)

In some embodiments, the system 100 synthesizes a report documenting the entire reproduction attempt. This report integrates logs and digital traces from all previous steps. It is implemented either directly via the logging statements of all previous steps, via a templating engine such as Jinja2, or via an LLM that takes as input the logs, digital traces of the previous steps, and a formal specification of reproducibility report, and outputs a report that reflects the input information and conforms to the specification.

### A Note on Flexibility:

In some embodiments, any step or combination of steps in the pipeline can be performed either by the automated system or manually, such that the end-to-end process is completed via a hybrid human-AI workflow. Furthermore, steps may be performed in concurrently or in orders different than that described herein.

In some embodiments, if any of the steps can be performed by the automated system, then it becomes possible to use that component to assist a fully manual human-only pipeline. For example, consider the workspace construction module. A person performing a manual reproduction attempt who has completed the antecedent steps could hand off the workspace construction step to the automated system, using it is to replace or enhance their own attempt to construct the workspace.

In some embodiments, the disclosed system 100 and method 200 may comprise the step of autodebugging any analysis (e.g., an analysis that failed to compile a provided code). In some embodiments, the system 100 and method 200 may provide remediating steps, fixes and/or recommendations for a paper that was not reproducible such as constructive changes, changes to dependencies, changes to work-flow, plug-in recommendations, changes to code, fixes for code, etc.

In some embodiments, additional remediations may include (i) environment normalization (pin/upgrade/downgrade dependencies; select legacy runtimes; set seeds, locale, time-zone, and thread counts), (ii) platform substitution (CPU↔GPU fallbacks; alternative BLAS/LAPACK; legacy OS images or VM emulation), (iii) data repair & recovery (checksum verification; re-download; decompress/convert formats; fix delimiters/encodings/line endings; OCR tables/figures; impute or recompute derived variables from methods), (iv) code repair (auto-lint/format; transpilation; API shims for deprecated calls; synthesis of missing functions/tests from specification, debugging), (v) analysis workflow surgery (reorder steps; adjust resource limits; chunk/batch; cache intermediates; memoize; recompute missing artifacts), or (vi) other forms of routine debugging, such as fixing syntax errors such as mismatched brackets, indentation, or unclosed strings; resolving missing imports or incorrect package/module names; updating deprecated API calls to their current equivalents; adjusting function signatures to match expected argument order or keyword usage; repairing type errors through explicit casts or annotations; inserting seed initializations to ensure reproducibility in randomized algorithms; correcting file path references, encodings, or line-ending mismatches; replacing hard-coded absolute paths with relative or configurable paths; patching broken regular expressions; repairing loop constructs to address off-by-one errors, infinite iterations, or missing break/continue statements; adjusting indexing errors in arrays, tensors, or DataFrames; correcting variable scope issues such as undefined variables or shadowed names; adding error handling and try-catch blocks around fragile I/O calls; rewriting shell commands for portability across operating systems; resolving version conflicts between libraries by pinning, upgrading, or shimming APIs; transpiling or backporting code across language versions (e.g., Python 2→3, R 3.x→4.x); converting between notebooks and scripts; adding missing entry points or CLI wrappers; repairing documentation strings or usage examples to remain consistent with the underlying code; injecting unit tests or assertions for intermediate outputs to help localize failures; and, when necessary, generating stubs for missing functions or classes from pseudocode or algorithm descriptions.

In some embodiments, the disclosed system and method may comprise the step of providing a reproducibility assessment score prior to running the analysis based on a comparison of the paper with a database of other papers reproduced by the system 100 and method 200. In some embodiments, the score reflects a binary outcome of successful vs. non-successful reproduction. Alternatively, it might compute the number of steps that succeed, or the difference between the reproduced results and the original results. In some embodiments, the disclosed system may be deployed as a package on a remote or private server.

### EXPERIMENTAL EXAMPLES

The invention is now described with reference to the following Examples. These Examples are provided for the purpose of illustration only and the invention should in no way be construed as being limited to these Examples, but rather should be construed to encompass any and all variations which become evident as a result of the teaching provided herein.

Without further description, it is believed that one of ordinary skill in the art can, using the preceding description and the following illustrative examples, make and utilize the present invention and practice the claimed methods. The following working examples therefore specifically point out exemplary embodiments of the present invention, and are not to be construed as limiting in any way the remainder of the disclosure.

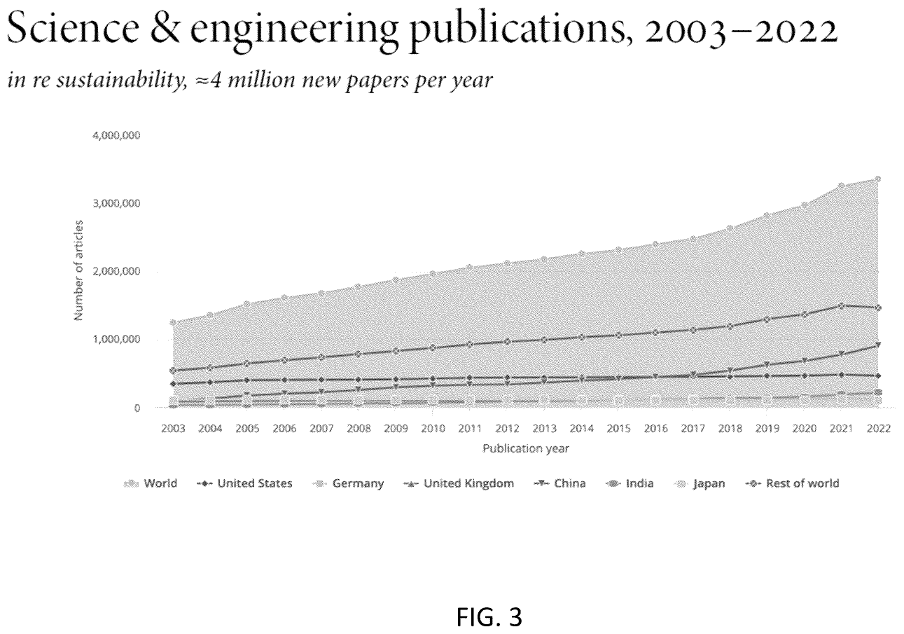

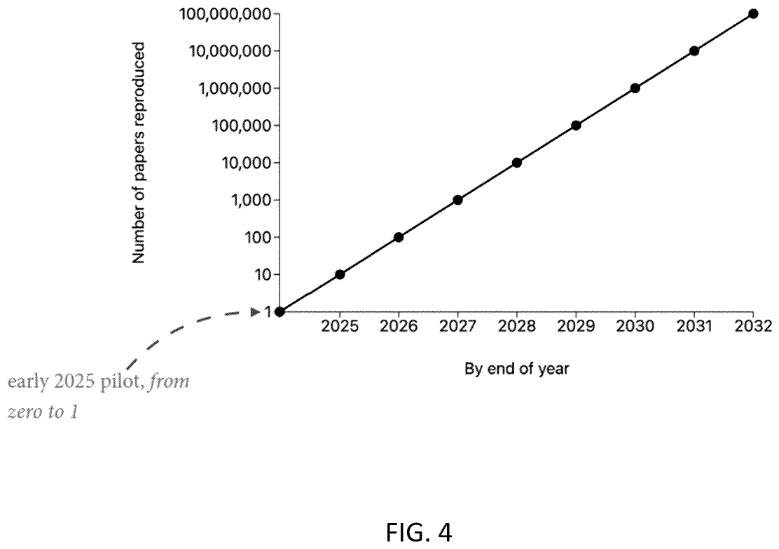

FIG. 3 shows a plot of scientific and engineering publications over time. FIG. 4 shows a plot of a simulation of scientific and engineering publications reproduced using the systems and methods herein over time.

The following is an exemplary application of the system 100 and method 200. For example, for the DoD testing community, the system offers a powerful tool for assessing the credibility of research findings they may rely on. It can be integrated into existing frameworks for evaluating scientific claims, providing an objective measure of computational reproducibility as part of a broader credibility assessment. Testing communities can use the system to automatically verify computational results before incorporating them into decision-making processes, track the reproducibility status of research products over time, and/or identify potential reliability issues early in the evaluation process.

The process begins with a first milestone where for a single paper, given only that paper's DOI, the system automatically produces a fully verifiable audit trail of the paper's computational reproducibility. The process then proceeds to a second milestone, where given only the DOIs of all papers included in past manual audits (e.g., as part of the DARPA SCORE project) the system replicates all those reproduction attempts (by producing fully verifiable audit trails of all those paper's computational reproducibility) in under 24 hours.

The core technical challenges in automating computational reproducibility verification stem from the complexity and variability of how scientific work is documented and implemented. Papers describe their computational methods in natural language with varying levels of detail and precision, often referencing code in repositories that may no longer exist or data that isn't publicly available. Even when all components are available, recreating the exact computational environment is challenging—papers depend on specific versions of software and libraries that may be outdated or have conflicting dependencies. The verification process itself presents unique challenges where different numerical implementations can produce slightly different results while still being fundamentally correct, making exact matching impossible in many cases. Additionally, processing papers at scale within our 24-hour target requires sophisticated resource allocation and parallel processing capabilities. These challenges are addressed through a multi-layered approach, using AI-driven document analysis to extract and standardize computational methods, implementing containerized environments for reproducible execution, developing statistical equivalence testing for result verification, and/or creating a distributed processing pipeline that can efficiently handle multiple papers simultaneously. The system is designed to fail gracefully, providing partial verification when full reproduction isn't possible and clearly documenting what aspects could and couldn't be verified.

Success metrics are as follows. Perform reproducibility audits with 90% accuracy compared to human audits, as measured on a test set of approximately 1,000 papers that have previously been audited manually. Successfully identify and recreate required computing environments in 85% of cases where all dependencies are theoretically available. Achieve 99% accuracy in detecting when critical resources (code, data, environment specifications) are missing. Generate audit trails that include complete dependency graphs of all computational artifacts, versioned records of all execution attempts and outcomes, detailed logs of any verification failures with root cause analysis, and/or standardized reproducibility reports matching current best practices in manual computational reproducibility audits. Achieve system performance of under 24 hours per paper, even with complex computational workflows involving multiple analysis steps.

Further notes of the example follow. As defined above, the system begins with the specification of a DOI. However, sometimes a DOI is not available for a scientific artifact. For example, a paper may have been published before the DOI system was created and no DOI may have been associated with the work post-publication, or the paper might appear in a journal that does not issue DOIs. In this case, there are a few paths forward. One is for the system to proactively issue a DOI. Another is to record some other stable identifier associated with the paper, e.g. an SHA256 hash. One challenge associated with recording hashes of papers is that many sites create custom per-download PDF assets for digital rights management purposes. Once a DOI is resolved to a given website, there is still sometimes the hashing issue described above.

Some computational analyses are probabilistic in nature. There is thus a tension between defining reproducibility with respect to original execution (e.g., seeded PRNG) versus whether that analysis will reliably produce the reported result. That is, it's possible for the paper to be fully computationally reproducible with respect to the PRNG seed that was chosen, but for it to nonetheless report a result that is wrong because the computational reproducible work is incorrect. This points out the distinction between correctness and reproducibility. Thus it may be necessary in some cases to use an LLM that allows seeding its own PRNG if the audits to themselves are to be reproducible.

Additionally, many scientific analyses are expensive. How can one reproduce an analysis that is so expensive it can only be carried out once? Well, it's possible that those projects are inherently computationally irreproducible. Being irreproducible doesn't mean there is no value in the project, it means that the basis of trust must come from outside of the process of independent verification.

Another possible issue is that often data cannot be shared. How can one verify computational reproducibility in that case? Often it is possible to share derivative datasets from the original “raw” data (e.g., with PII scrubbed, or summary statistics from which the downstream analysis can proceed). Again, this is about the basis of trust in each research result. In some cases it may be necessary to trust the derivative data as much as one can trust the “raw” data.

### Computing Environment

Accordingly the aforementioned systems may include one or more computing devices communicatively and/or operatively connected to the systems for performing one or more steps of any of the disclosed methods. For example, in some embodiments, the computing devices enable deep learning, machine learning and/or artificial intelligence with various networks (e.g., neural networks) and algorithms. In some aspects of the present invention, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled or interpreted, including but not limited to C, C++, C #, Objective-C, Java, JavaScript, MATLAB, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth®, Bluetooth® Low Energy (BLE) or Zigbee® communication links, or any other method by which one electronic device is capable of communicating with another. In some embodiments, elements of the networked portion of the invention may be implemented over a Virtual Private Network (VPN).

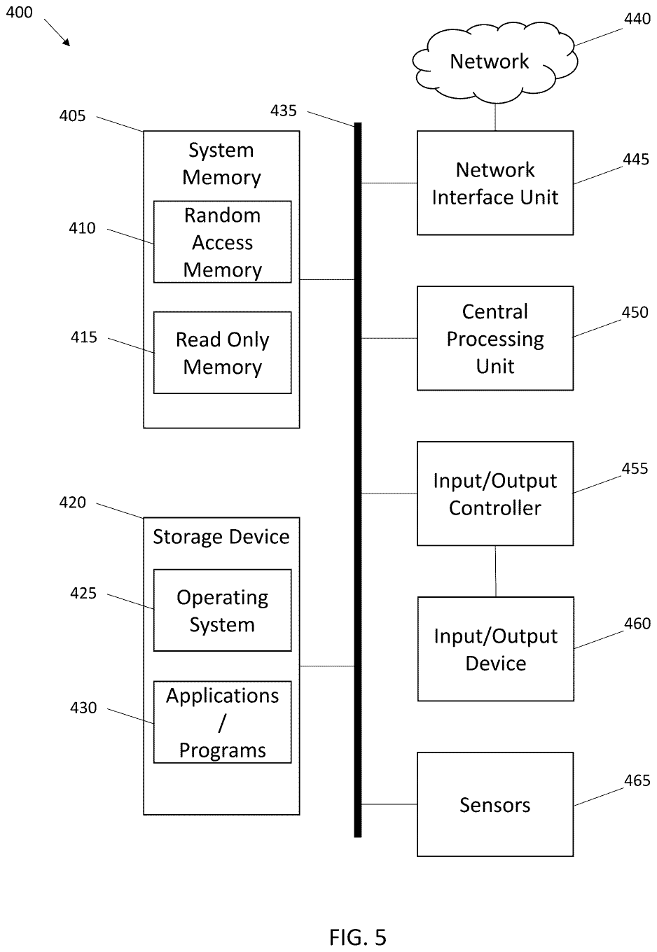

FIG. 5 and the following discussion are intended to provide a brief, general description of a suitable computing environment in which the invention may be implemented. While the invention is described above in the general context of program modules that execute in conjunction with an application program that runs on an operating system on a computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

FIG. 5 depicts an illustrative computer architecture for a computer 400 for practicing the various embodiments of the invention. The computer architecture shown in FIG. 5 illustrates a conventional personal computer, including a central processing unit 450 (“CPU”), a system memory 405, including a random-access memory 410 (“RAM”) and a read-only memory (“ROM”) 415, and a system bus 435 that couples the system memory 405 to the CPU 450. A basic input/output system containing the basic routines that help to transfer information between elements within the computer, such as during startup, is stored in the ROM 415. The computer 400 further includes a storage device 420 for storing an operating system 425, application/program 430, and data.

The storage device 420 is connected to the CPU 450 through a storage controller (not shown) connected to the bus 435. The storage device 420 and its associated computer-readable media, provide non-volatile storage for the computer 400. Although the description of computer-readable media contained herein refers to a storage device, such as a hard disk or CD-ROM drive, it should be appreciated by those skilled in the art that computer-readable media can be any available media that can be accessed by the computer 400.

By way of example, and not to be limiting, computer-readable media may comprise computer storage media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the computer 400 may operate in a networked environment using logical connections to remote computers through a network 440, such as TCP/IP network such as the Internet or an intranet. The computer 400 may connect to the network 440 through a network interface unit 445 connected to the bus 435. It should be appreciated that the network interface unit 445 may also be utilized to connect to other types of networks and remote computer systems.

The computer 400 may also include an input/output controller 455 for receiving and processing input from a number of input/output devices 460, including a keyboard, a mouse, a touchscreen, a camera, a microphone, a controller, a joystick, or other type of input device. Similarly, the input/output controller 455 may provide output to a display screen, a printer, a speaker, or other type of output device. The computer 400 can connect to the input/output device 460 via a wired connection including, but not limited to, fiber optic, ethernet, or copper wire or wireless means including, but not limited to, Bluetooth, Near-Field Communication (NFC), infrared, or other suitable wired or wireless connections.

As mentioned briefly above, a number of program modules and data files may be stored in the storage device 420 and RAM 410 of the computer 400, including an operating system 425 suitable for controlling the operation of a networked computer. The storage device 420 and RAM 410 may also store one or more applications/programs 430. In particular, the storage device 420 and RAM 410 may store an application/program 430 for providing a variety of functionalities to a user. For instance, the application/program 430 may comprise many types of programs such as a word processing application, a spreadsheet application, a desktop publishing application, a database application, a gaming application, internet browsing application, electronic mail application, messaging application, and the like. According to an embodiment of the present invention, the application/program 430 comprises a multiple functionality software application for providing word processing functionality, slide presentation functionality, spreadsheet functionality, database functionality and the like.

The computer 400 in some embodiments can include a variety of sensors 465 for monitoring the environment surrounding and the environment internal to the computer 400. These sensors 465 can include a Global Positioning System (GPS) sensor, a photosensitive sensor, a gyroscope, a magnetometer, thermometer, a proximity sensor, an accelerometer, a microphone, biometric sensor, barometer, humidity sensor, radiation sensor, or any other suitable sensor.

In some embodiments, the disclosed system may comprise a user interface (UI) such as a graphical user interface (GUI) for arranging and presenting any aspects of the disclosed systems and methods such as augmented reality, patient data, information, results and analysis. In some embodiments, the UI or GUI is produced to a wearable device, such as a set of smart-glasses, or to a display. In some embodiments, the UI or GUI enables any of: displaying patient data, displaying patient imaging, stress modelling, overlays of live imaging, augmented reality, mixed reality, audiovisual artificial intelligence (AVAI) and video electroencephalography (vEEG).

Aspects of the invention relate to machine learning executed on a computing device, wherein the computing device may be computer 400. In some embodiments, the disclosed system and method utilize machine learning algorithms and models, including one or more neural networks, that may operate on at least one computing device (e.g., computer 400). The disclosed system may employ various types of neural networks known in the art, including but not limited to feedforward neural networks (FNNs), convolutional neural networks (CNNs), recurrent neural networks (RNNs), transformer networks, autoencoders, generative adversarial networks (GANs), Radial Basis Function Networks (RBFNs), extreme learning machines (ELMs), quantum neural networks (QNNs), and deep neural networks (DNNs).

Machine learning is a branch of artificial intelligence (AI) that enables systems to learn and improve from experience without being explicitly programmed. Machine learning models analyze data sets to identify patterns and correlations, and then uses those patterns to make predictions or decisions. Machine learning models can generally be categorized into three primary types: supervised learning, unsupervised learning, and semi-supervised learning.

Supervised learning involves training a model using labeled datasets to classify data or predict outcomes accurately. As input data is fed into the model, the model adjusts its internal parameters (e.g., weights) to minimize prediction errors. Common methods used in supervised learning include neural networks, naïve Bayes classifiers, linear regression, logistic regression, random forests, and support vector machines (SVMs).

Classification is a common task in supervised learning, where data inputs are categorized into distinct classes. Classification models may include binary classifiers (e.g., spam vs. non-spam) and multi-class classifiers (e.g., identifying different species of animals). A decision tree is a widely used classification method that applies a sequence of “if-then” conditions to narrow down possible outcomes.

Regression is another form of supervised learning where the output is a continuous variable rather than a discrete category. Linear regression predicts a continuous value based on a linear relationship between inputs and outputs, while logistic regression predicts categorical outcomes based on defined inputs.

Unsupervised learning involves analyzing unlabeled datasets to identify hidden patterns or groupings without human intervention. Principal component analysis (PCA) and singular value decomposition (SVD) are common techniques used to reduce data dimensionality and reveal underlying structures.

Clustering is a key unsupervised learning technique where data points are grouped based on shared features or proximity. K-means clustering is a widely used method where the number of clusters is defined by a variable “k,” and the algorithm iteratively adjusts cluster centroids to minimize variance within each cluster. Other clustering methods include hierarchical clustering and probabilistic clustering.

Semi-supervised learning combines elements of both supervised and unsupervised learning. A model is initially trained using a smaller labeled dataset, which then guides the classification and feature extraction from a larger unlabeled dataset. Semi-supervised learning is particularly useful when acquiring large amounts of labeled data is costly or impractical.

Multi-modal sensing machine learning involves combining data from multiple sensors (like cameras, microphones, and radar) to create a more complete and accurate understanding of the environment. This approach leverages the strengths of different sensors, allowing machines to “see” and “hear” the world in a way that's more like human perception, and improves the performance of machine learning models in tasks like object recognition, scene understanding, robot navigation.

Deep learning is a subfield of machine learning that uses neural networks with multiple hidden layers to process and analyze complex data. Neural networks mimic the structure and function of the human brain, comprising layers of interconnected nodes (neurons). Each neuron receives input data, applies a transformation based on assigned weights, and passes the result to the next layer.

A typical neural network comprises of: input layer—receives raw data inputs; hidden layer(s)—applies mathematical transformations using weighted connections; and output layer—generates the final prediction or classification.

Convolutional neural networks (CNNs) are a type of neural network particularly well-suited for processing image and spatial data. CNNs use convolutional layers to extract spatial features from input data, pooling layers to reduce dimensionality, and fully connected layers to generate output predictions.

Deep neural networks (DNNs) are composed of multiple hidden layers and are capable of learning complex patterns in large datasets. Recurrent neural networks (RNNs) are a type of deep learning network designed for sequential data, such as time series or natural language, where previous inputs influence future outputs. Long short-term memory (LSTM) networks are a specialized form of RNN that mitigates issues with long-term dependencies.

Generative Adversarial Networks (GANs) are a class of machine learning models in which two neural networks—a generator and a discriminator—are trained together in a competitive framework. The generator creates synthetic data (e.g., images, audio) from random noise, while the discriminator evaluates whether the generated data is real or fake. The generator improves its output by trying to fool the discriminator, while the discriminator becomes better at distinguishing real data from generated data. This adversarial process drives both networks to improve over time, leading to the generation of highly realistic data.

Types of GANs include: Vanilla GAN—The original GAN model, where the generator and discriminator are trained using a minimax loss function. Deep Convolutional GAN (DCGAN)—Uses convolutional layers instead of fully connected layers, improving the quality of generated images. Conditional GAN (cGAN)—Conditions the generation process on class labels or other input data, enabling targeted generation (e.g., generating images of specific objects). Wasserstein GAN (WGAN)—Introduces the Wasserstein distance (Earth Mover's distance) as the loss function, which improves training stability and reduces mode collapse (when the generator produces limited variations of data). WGAN-GP (Wasserstein GAN with Gradient Penalty)—Improves WGAN by adding a gradient penalty to enforce the Lipschitz constraint, further enhancing training stability. CycleGAN—Used for unpaired image-to-image translation (e.g., converting paintings to photos) by enforcing consistency between the forward and backward transformations. StyleGAN—Generates high-resolution and highly detailed images using a style-based generator architecture, allowing greater control over features like face shape and texture. GANs are widely used in fields such as computer vision, natural language processing, and creative design, but they can be difficult to train due to instability and mode collapse—challenges that models like WGAN and WGAN-GP address effectively.

Furthermore, aspects of the disclosed systems and methods may be practiced on an MCP server. An MCP server is an external server that uses a standardized interface to expose tools that an LLM agent can make use of. With an MCP service it is possible to realize two alternative implementations of the disclosed systems and methods. In one, the system does not carry out the steps sequentially, but instead provides an MCP server that can perform any of the steps in whatever order is requested by an LLM agent making a request to that MCP server. In the second, the system does not carry out the steps sequentially, but instead uses an internal LLM agent that is prompted to carry out the steps sequentially by making requests to the MCP server that provides the individual tools. These two instantiations are related and differ only in whether the LLM agent that is carrying out the reproduction attempt is internal to the system (second example) or external to it (first example).

In some embodiments, the disclosed system may include an AI model trained using reinforcement learning, where an agent learns to make decisions through trial and error by interacting with an environment and receiving feedback in the form of rewards or penalties.

### REFERENCES

The following publications are each hereby incorporated herein by reference in their entirety:
Baker, M. (2016). 1,500 scientists lift the lid on reproducibility. Nature, 533(7604), 452-454. https://www.nature.com/articles/533452a
Stodden, V., et al. (2018). An empirical analysis of journal policy effectiveness for computational reproducibility. PNAS, 115(11), 2584-2589. https://www.pnas.org/content/115/11/2584
Project Jupyter. (2018). Binder 2.0—Reproducible, interactive, sharable environments for science at scale. https://conference.scipy.org/proceedings/scipy2018/pdfs/project_jupyter.pdf
National Academies of Sciences, Engineering, and Medicine. (2019). Reproducibility and Replicability in Science. https://www.nap.edu/catalog/25303/

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention.

What is claimed is:

1. A system for automated computational reproducibility auditing of scientific research, comprising:
an input processing pipeline comprising an identity resolution module, a paper retrieval module, and a resource discovery module;
an analysis pipeline comprising a text extraction module, a result extraction module, and a bill of materials construction module;
a reconstruction and execution environment comprising a workspace reconstruction module, an analysis execution module, and a result comparison module; and
a computing system communicatively connected to the input processing pipeline, analysis pipeline, and reconstruction and execution environment, comprising a processor and a non-transitory computer-readable medium with instructions stored thereon, which when executed by the processor, perform steps comprising:
receiving as input a paper identifier or informal descriptor;
acquiring a digital form of the identified paper;
extracting structured information from the paper;
identifying key results from the paper which will be targeted for reproduction;
constructing a bill of materials for the scientific work described in the paper;
obtaining necessary data files and code;
synthesizing a scientific workflow specification;
synthesizing a computation environment specification;
constructing a workspace;
executing analysis of the scientific workflow;
comparing results obtained through reproduction with the key results extracted from the original paper; and
synthesizing a report documenting the entire reproduction attempt.

2. The system of claim 1, further comprising a reproducibility pipeline comprising a reproducibility package generation module, and a distributed processing infrastructure.

3. The system of claim 1, further comprising machine learning subsystems comprising a large language model (LLM) integration for methods interpretation, and feedback loops for adaptive learning from past audits.

4. A method for automated computational reproducibility auditing of scientific research, comprising:
receiving as input a paper identifier or informal descriptor;
acquiring a digital form of the identified paper;
extracting structured information from the paper;
identifying key results from the paper which will be targeted for reproduction;
constructing a bill of materials for the scientific work described in the paper;
obtaining necessary data files and code;
synthesizing a scientific workflow specification;
synthesizing a computation environment specification;
constructing a workspace;
executing analysis of the scientific workflow to produce a reproduced set of results corresponding to the key results;
comparing the reproduced set of results with the key results extracted from the original paper; and
synthesizing a report documenting the entire reproduction attempt.

5. The method of claim 4, wherein the received a formal identifier comprising a Digital Object Identifiers (DOIs), a URL pointing to a preprint or a journal article, a PubMed ID, or an OpenAlex ID, or wherein the received informal descriptor comprises a citation, a quote from the paper, or an author name and publication year.

6. The method of claim 4, further comprising resolving the provided identifier to include up-to-date information about the paper it identifies, wherein the resolving is performed via a DOI resolution service, a related system, a general-purpose search engine, or domain-specific search engine.

7. The method of claim 4, further comprising retrieving metadata for the paper via a query service or metadata provider, wherein the metadata includes information about the paper comprising at least one of a title, an author, an abstract, a keyword, a journal and associated information, a publication date, a citation data, and a disciplinary classification.

8. The method of claim 4, wherein step of acquiring the digital form of the identified paper comprises an adaptive approach comprising at least one of making direct HTTP requests to known URLs, utilizing a query service to locate freely available versions, accessing via a subscription services, using alternative sources, contacting authors directly via email, deploying web crawlers to extract papers from websites lacking formal APIs, retrieving papers from preprint servers, and accessing bulk data downloads from publishers or aggregators.

9. The method of claim 4, wherein the structured information comprises at least one of a text, a table, and a figure.

10. The method of claim 4, wherein identifying key results from the paper which will be targeted for reproduction comprises at least one of using tools from natural language processing (NLP) that perform extractive summarization or abstractive summarization, and using a large language model (LLM) that leverages broad domain knowledge across scientific fields to accurately interpret results across different disciplines and presentation formats.

11. The method of claim 4, wherein the step of constructing a bill of materials for the scientific work described in the paper comprises using a dependency crawler to examine contents of the paper and metadata to extract dependencies and new location pointers, process dependencies that are at least one of explicitly defined and well-specified, explicitly defined but poorly specified, and implicitly defined.

12. The method of claim 4, wherein the step of obtaining necessary data files and code comprises obtaining the data files and code via at least one of a direct HTTP request to relevant servers, a specialized archival lookup tool or an application programming interface (API), a web crawler for sites without formal APIs, a paid service when necessary, and domain-specific search engine.

13. The method of claim 4, wherein the step of synthesizing a scientific workflow specification comprises generating a formal specification of the scientific workflow described in the paper, wherein the specification takes the form of a domain-specific language script or a domain-general language implementation, wherein the specification captures the sequence of at least one of analytical steps, data transformations, and computational procedures necessary to reproduce the paper's results.

14. The method of claim 4, wherein the step of synthesizing a computation environment specification comprises generating a specification of the computational environment required to execute the workflow, wherein the computation environment specification includes at least one of container definitions, Linux container configurations, declarative environment definitions, virtual machine specifications, infrastructure as code templates, and Kubernetes manifests.

15. The method of claim 4, wherein the step of constructing a workspace comprises a workspace manager creating and populating a structured environment for the reproduction attempt by performing at least one of establishing an appropriate directory structure, populating the workspace with the obtained data files and code, implementing appropriate access controls and resource allocations, creating virtual environments or containers based on the environment specification, and setting up appropriate configuration files.

16. The method of claim 4, wherein the step of executing analysis of the scientific workflow comprises using appropriate workflow management tools such that execution follows the formal workflow specification, operates within the computational environment, uses the constructed workspace, records detailed logs of all operations and intermediate outputs, and tracks resource utilization and execution time, wherein the execution performs the actual computational reproduction of the paper's analysis.

17. The method of claim 4, further comprising, when execution errors occur, debugging and refining the analysis via an AI debugging module with tool use capabilities to at least one of identify and diagnose execution errors, examine output logs and error messages, suggest and implement fixes for identified issues, resolve dependency conflicts by testing various configurations, modify code or workflow specifications as needed, and retry execution with corrected parameters.

18. The method of claim 4, wherein the step of comparing results obtained through reproduction with the key results extracted from the original paper comprises using comparison tools employing statistical methods to at least one of performing statistical tests across multiple runs to account for stochasticity, assessing whether observed differences fall within acceptable ranges for the discipline, and producing a graded assessment of reproduction success.

19. The method of claim 4, wherein the step of synthesizing a report documenting the entire reproduction attempt comprises integrating logs and digital traces from all previous steps, wherein the synthesizing is implemented directly via logging statements of all previous steps, via a templating engine, or via an LLM that takes as input the logs, digital traces of the previous steps, and a formal specification of reproducibility report, and outputs a report that reflects the input information and conforms to the specification.

20. A non-transitory computer-readable medium storing instructions that, when executed by a processor, cause the processor to perform method steps comprising:
receiving as input a paper identifier or informal descriptor;
acquiring a digital form of the identified paper;
extracting structured information from the paper;
identifying key results from the paper which will be targeted for reproduction;
constructing a bill of materials for the scientific work described in the paper;
obtaining necessary data files and code;
synthesizing a scientific workflow specification;
synthesizing a computation environment specification;
constructing a workspace;
executing analysis of the scientific workflow;
comparing results obtained through reproduction with the key results extracted from the original paper; and
synthesizing a report documenting the entire reproduction attempt.
